(19) United States
(12) Patent Application Publication
(10) Pub. No.: US 2007/0185302 A1
(43) Pub. Date: Aug. 9, 2007

(54) Polyurethane elastomers comprising allophanate modified isocyanates

(75) Inventors: Stephen J. Harasin, Morgan, PA (US); Richard R. Roesler, Wexford, PA (US); Rick V. Starcher, Monaca, PA (US); Carol L. Kinney, Eighty Four, PA (US); James Garrett, Palmyra, VA (US)

Correspondence Address: BAYER MATERIAL SCIENCE LLC, 100 BAYER ROAD, PITTSBURGH, PA, 15205, US

(73) Assignee: Bayer MaterialScience LLC

(21) Appl. No.: 11/350,316

(22) Filed: Feb. 8, 2006

(51) Int. Cl. C08G 18/00

(52) U.S. Cl. 528/44

(57) ABSTRACT

This invention relates to polyurethane elastomers and to a process for their production. These elastomers comprise the reaction product of a polyisocyanate component comprising an allophanate modified (cyclo)aliphatic polyisocyanate which has an NCO group content of about 15 to about 35% or a prepolymer thereof, with an isocyanate-reactive component comprising one or more polyether polyols which is free of amine groups, and a low molecular weight organic compound containing two hydroxyl groups and which is free of amine groups, in the presence of one or more catalysts.

### BACKGROUND OF THE INVENTION

This invention relates to polyurethane elastomers which exhibit improved weather resistance and to a process for their production.

The production of polyurethane moldings via the reaction injection molding (i.e. RIM) technique is well known and described in, for example, U.S. Pat. No. 4,218,543. The RIM process involves a technique of filling the mold by which highly reactive, liquid starting components are injected into the mold within a very short time by means of a high output, high pressure dosing apparatus after they have been mixed in so-called “positively controlled mixing heads”.

In the production of polyurethane moldings via the RIM process, the reaction mixture generally comprises an A-side based on polyisocyanates and a B-side based on organic compounds containing isocyanate-reactive hydrogen atoms, in addition to suitable chain extenders, catalysts, blowing agents, and other additives. The polyisocyanates which are suitable for a commercial RIM process are the aromatic isocyanates such as, for example, diphenylmethane-4,4′-diisocyanate (i.e. MDI). While various patents broadly disclose cycloaliphatic isocyanates in a long list of isocyanates which are described as suitable for use in a RIM process, few patents have any working examples wherein a cycloaliphatic isocyanate is used.

U.S. Pat. 4,772,639 describes a process for the production of polyurethane moldings reacting organic polyisocyanates with organic compounds containing isocyanate-reactive hydrogen atoms in the presence of catalysts and auxiliary agents inside a closed mold. The isocyanate component is based on (a1) mixtures of (i) 1-isocyanate-3,3,5-trimethyl-5-isocyanatomethylcyclohexane (IPDI), and (ii) polyisocyanates containing isocyanurate groups prepared by the trimerization of a portion of the isocyanate groups of 1,6-diisocyanatohexane, or (a2) (i) IPDI and (iii) polyisocyanates containing isocyanurate groups prepared by the trimerization of a portion of the isocyanate groups of a mixture of 1,6-diisocyanatohexane and IPDI. These reaction mixtures are broadly disclosed as being suitable for RIM processing.

U.S. Pat. No. 4,642,320 discloses a process for the preparation of a molded polymer comprising reacting inside a closed mold a reaction mixture comprising (a) an active hydrogen containing material comprising a primary or secondary amine terminated polyether having an average equivalent weight of at least 500, (b) at least one chain extender, and (c) a (cyclo)aliphatic polyisocyanate, polyisothiocyanate, or mixture thereof, wherein the NCX index is from about 0.6 to 1.5. This process requires that component (a) have at least 25%, and preferably 50% of its active hydrogen atoms present in the form of amine hydrogens. All of the examples disclose a system based on a HDI prepolymer with amine terminated polyethers and diethyltoluenediamine at high mold temperatures and long demold times.

U.S. Pat. No. 4,764,543 discloses aliphatic RIM systems that use very fast reacting aliphatic polyamines. This patent is restricted to total polyurea systems based on chain extenders which are cycloaliphatic diamines and polyethers which are amine-terminated polyethers, with an aliphatically bound polyisocyanate.

RIM systems are also disclosed in U.S. Pat. No. 4,269,945. These systems are based on compositions comprising a polyisocyanate, a hydroxyl-containing polyol, and a specific chain extender. The specific chain extender comprises (1) at least one component selected from the group consisting of (a) a hydroxyl-containing material which is essentially free of aliphatic amine hydrogen atoms, and (b) aromatic amine-containing materials containing at least two aromatic amine hydrogen atoms and are essentially free of aliphatic amine hydrogen atoms; and (2) at least one aliphatic amine-containing material having at least one primary amine group and an average aliphatic amine hydrogen functionality of from about 2 to 16. Both aromatic polyisocyanates and (cyclo)aliphatic polyisocyanates are disclosed as being suitable for this process. All of the working examples in this patent use aromatic isocyanates that may be polymeric in nature.

U.S. Pat. No. 5,260,346 also discloses reaction systems for preparing elastomers via the RIM process. These systems require an allophanate modified polyisocyanate, a hydroxyl group containing polyol, and an aromatic polyamine in which at least one of the positions ortho to the amine group is substituted with a lower alkyl substituent.

U.S. Pat. No. 5,502,147 describes (cyclo)aliphatic isocyanate based RIM systems. These (cyclo)aliphatic isocyanates have a viscosity of less than 20,000 mPa·s at 25° C., an NCO functionality of 2.3 to 4.0, and are modified by isocyanurate groups, biuret groups, urethane groups, allophanate groups, carbodiimide groups, oxadiazine-trione groups, uretdione groups, and blends thereof. The B-side comprises a high molecular weight polyol and a low molecular weight chain extender in which the OH:NH ratio is from 1:1 to 25:1.

U. S. Pat. No. 5,502,150, which is commonly assigned, discloses a RIM process which uses a hexamethylene diisocyanate prepolymer having a functionality of less than 2.3, an NCO content of 5 to 25%, and a monomer content of less than 2% by weight. This prepolymer is reacted with a high molecular weight isocyanate-reactive compound, a chain extender selected from diols and aminoalcohols, and a hydroxyl-based crosslinking compound containing no more than one aliphatic amine hydrogen atom.

Light stable polyurethanes are also disclosed in U.S. Pat. Nos. 5,656,677 and 6,242,555. The polyurethanes of U.S. Pat. No. 5,656,677 comprise the reaction product of a (cyclo)aliphatic isocyanate with a compound containing isocyanate-reactive hydrogen atoms, in the presence of a chain extender and/or crosslinker, and a specific catalyst system. The catalyst system comprises 1) at least one organic lead compound, 2) at least one organic bismuth compound, and/or 3) at least one organic tin compound. The light stable elastomers of U.S. Pat. No. 6,242,555 comprise the reaction product of A) isophorone diisocyanate trimer/monomer mixture having an NCO group content of 24.5 to 34%, with B) an isocyanate-reactive component, in the presence of C) at least one catalyst selected from organolead (II), organobismuth (III) and organotin (IV) compounds.

A method of producing window gaskets from polyurethane/urea compositions is disclosed in U.S. Pat. No. 5,770,674. These compositions comprise the reaction product of a (cyclo)aliphatic polyisocyanate having an NCO functionality of 2.0 to 4.0; with an isocyanate-reactive component comprising a relatively high molecular weight organic compound containing hydroxyl groups, amine groups or mixtures thereof; and a low molecular weight chain extender selected from diols, primary amines, secondary amines aminoalcohols and mixtures thereof; with the resultant composition having a crosslink density of at least 0.3 moles/kg.

U.S. application Ser. No. 11/300,958, filed Dec. 15, 2005, which is commonly assigned, discloses fast curing aliphatic RIM elastomers. These elastomers comprise (1) an isocyanate component having an NCO group content of about 20 to about 45% by weight, a functionality of about 2.0 to about 2.7, and comprising a trimerized (cyclo)aliphatic pblyisocyanate, with (2) a high molecular weight polyether polyol that is free of amine groups and a low molecular weight compound that is also free of amine groups, in the presence of (3) one or more catalysts.

U.S. application Ser. No. 11/304,265, filed Dec. 15, 2006, which is also commonly assigned, is directed to improved weather resistant polyurethane elastomers. These elastomers comprise (1) an isocyanate component having an NCO group content of about 20 to about 45% by weight, a functionality of about 2.0 to about 2.7, and comprising a trimerized (cyclo)aliphatic polyisocyanate, with (2) a high molecular weight polyether polyol having low unsaturation, a low molecular weight compound that is free of amine groups, and, optionally, a low molecular weight compound that is amine-initiated, in the presence of (3) one or more catalysts.

Polyurethane elastomers are also described in U.S. application Ser. No. 11/300,957, file Dec. 15, 2005, which is commonly assigned. These elastomers comprise (1) an allophanate modified isocyanate or prepolymer thereof, with (2) a high molecular weight polyether polyol having low unsaturation, a low molecular weight compound that is free of amine groups, and, optionally, a low molecular weight compound that is amine-initiated, in the presence of (3) one or more catalysts.

Advantages of the present invention include improved cure and simplified catalysis, without the need for a lead based catalyst. In addition, the elastomers of the present invention exhibit improved flexural modulus. These elastomers are also believed to exhibit improved weather resistance.

### SUMMARY OF THE INVENTION

This invention relates to polyurethane elastomers and to a process for their production.

These polyurethane elastomers comprise the reaction product of:
(A) a polyisocyanate component comprising (I) an allophanate-modified polyisocyanate having an NCO group content of about 15 to about 35% by weight, preferably of about 15 to about 25% by weight, and comprising the reaction product of:
   (1) a (cyclo)aliphatic polyisocyanate component having an NCO group content of about 25 to about 60%, preferably about 30 to about 50%,
   and
   (2) an organic alcohol selected from the group consisting of aliphatic alcohols containing from about 1 to about 36 carbon atoms, cycloaliphatic alcohols containing from about 5 to about 24 carbon atoms and aromatic alcohols containing from about 7 to about 12 carbon atoms in which the alcohol group is not directly attached to an aromatic carbon atom;
      with
(B) an isocyanate-reactive component comprising:
   (1) from about 70 to about 90% by weight, based on 100% by weight of (B), of one or more polyether polyols having a functionality of from about 2 to about 8 (preferably 2 to 4), a molecular weight of about 1000 to about 8,000 (preferably 2000 to 6000) and is free of (primary, secondary and/or tertiary) amine groups;
   and
   (2) from about 10 to about 30% by weight, based on 100% by weight of (B), of one or more organic compounds having a molecular weight of from about 62 to about 400, (preferably 62 to 90), having a hydroxyl functionality of 2 to 3, and is free of (primary, secondary and/or tertiary) amine groups,
      in the presence of
(C) one or more catalysts corresponding to the formula: 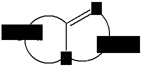
   wherein:
      m: represents an integer from 3 to 8, preferably from 3 to 4;
      and
      n: represents an integer from 3 to 8, preferably from 3 to 5;
         and, optionally,
(D) one or more additives (including ultraviolet stabilizers, pigments etc.).

The relative amounts of components (A) and (B) are such that the isocyanate index of the resultant elastomer ranges from about 100 to about 120, preferably 105 to 110.

In an alternate embodiment of the present invention, the allophanate modified polyisocyanates may be further reacted with an isocyanate-reactive component having a functionality of about 2 to about 6 and a molecular weight of about 60 to about 4,000 to form a prepolymer. The resultant prepolymers typically have an NCO group content of about 10 to about 30% by weight. These prepolymers of allophanate modified, (cyclo)aliphatic polyisocyanates may also be used as component (A) in accordance with the present invention.

The process for the production of these polyurethane elastomers comprising reacting a reaction mixture by a reaction injection molding technique. This reaction mixture corresponds to that described above.

### DETAILED DESCRIPTION OF THE INVENTION

Suitable polyoisocyanates for the present invention comprise (I) at least one allophanate modified (cyclo)aliphatic polyisocyanate. It is also possible that the polyisocyanates of the present invention comprise a prepolymer of these allophanate modified (cyclo)aliphatic polyisocyanates.

Suitable allophanate modified polyioscyanates suitable for the present invention typically have an NCO group content of about 15 to about 35% by weight, and preferably of about 15 to about 25% by weight. These allophanate modified polyisocyanates comprise the reaction product of (1) a (cyclo)aliphatic polyisocyanate which has an NCO group content of about 25 to about 60% by weight, and (2) an organic alcohol selected from the group consisting of aliphatic alcohols, cycloaliphatic alcohols and aromatic alcohols.

Suitable (cyclo)aliphatic polyisocyanates to be used as (1) in preparing the allophanate modified polyisocyanates (A)(I) of the present invention include, for example, 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3- and -1,4-diisocyanate, 1-isocyanato-2-isocyanatomethylcyclopentane, 1-isocyanato-3-isocyanatomethyl-3,5,5-trimethylcyclohexane (i.e. isophorone diisocyanate or IPDI), bis-(4-isocyanatocyclohexyl)methane, 2,4′-dicyclohexylmethane diisocyanate, 1,3- and 1,4-bis-(isocyanatomethyl)cyclohexane, bis-(4-isocyanato-3-methylcyclo-hexyl)methane,α,α′,α′-tetramethyl-1,3- and/or -1,4-xylylene diisocyanate, 1-isocyanato-1-methyl-4(3)-isocyanatomethylcyclohexane, dicyclohexylmethane-4,4′-diisocyanate, 2,4- and/or, 6-hexahydrotoluylene diisocyanate, and mixtures thereof. It is preferred that the isocyanate comprise 1,6-hexamethylene diisocyanate, dicyclohexylmethane-4,4′-diisocyanate, and 1-isocyanato-3-isocyanatomethyl-3,5,5-trimethylcyclohexane.

Suitable organic alcohols include aliphatic alcohols, cycloaliphatic alcohols and aromatic alcohols in which the alcohol group is not directly attached to an aromatic carbon atom. The aliphatic alcohols suitable for use as component (2) in preparing the allophanate-modified include those which contain from about 1 to about 36 carbon atoms, and preferably from about 1 to about 8 carbon atoms. Suitable cycloaliphatic alcohols include those which contain from about 5 to about 24 carbon atoms, and preferably from about 6 to about 10 carbon atoms. Suitable aromatic alcohols include those which contain from about 7 to about 12 carbon atoms, and preferably from about 8 to about 10 carbon atoms. In the aromatic alcohols suitable for the invention, the alcohol group is not directly attached to an aromatic carbon atom.

Some examples of suitable organic alcohols include, for example, aliphatic alcohols such as methanol, ethanol, propanol, isopropanol, n-butanol, isobutanol, n-pentanol, 1-methylbutyl alcohol, cetylalcohol, 2-methoxyethanol, 2-bromo-ethanol, etc.; cycloaliphatic alcohols such as cyclohexanol, cyclopentanol, cycloheptanol, hydroxymethyl cyclohexanol, etc.; and aromatic alcohols in which the alcohol group is not directly attached to an aromatic carbon atom such as, for example, benzyl alcohol, 2-phenoxy ethanol, cinnamyl alcohol, p-bromobenzyl alcohol, etc.

Allophanate modified polyisocyanates of hexamethylene diisocyanate (HDI) typically have an NCO content of 15 to 45%, and preferably 20 to 30% by weight. Allophanate modified polyisocyanates of dicyclohexylmethane diisocyanate (rMDI) typically have an NCO content of 15 to 35% and preferably 20 to 30% by weight. Allophanate modified polyisocyanates of isophorone diisocyanate (IPDI) typically have an NCO content of 15 to 35%, and preferably 20 to 30% by weight.

Allophanate modified polyisocyanates of the (cyclo)aliphatic polyisocyanates which are suitable for the present invention are prepared in the known manner. The (cyclo)aliphatic polyisocyanate is reacted with a suitable organic alcohol, in the presence of an allophanate catalyst at temperatures of about 60 to about 120° C., to form the allophanate modified polyisocyanate. Suitable allophanate catalysts include, for example, zinc acetylacetonate, zinc 2-ethylhexanoate, cobalt naphthenate, lead linoresinate, etc. Typically, these catalysts are neutralized or otherwise stopped from adversely affecting subsequent reaction by the addition of a catalyst stopper. Suitable catalyst stoppers include acidic materials such as, for example, anhydrous hydrochloric acid, sulfuric acid, bis(2-ethylhexyl)hydrogen phosphate, benzoyl chloride, Lewis acids, etc. The stopper is typically added in a ratio of about 2 equivalents of the acidic stopper to each mole of the allophanate catalyst.

In an alternate embodiment of the present invention, prepolymers of these allophanate modified polyisocyanates described above are also suitable to be used as the polyisocyanate component. These prepolymers typically have an NCO group content of about 10 to about 35%, preferably from about 12 to about 25% by weight. Also, the prepolymers typically have a functionality of at least about 2. These prepolymers also typically have a functionality of no more than about 6. Preparation of the prepolymer of the allophanate modified polyisocyanates of the present invention comprises reacting these allophanate modified (cyclo)aliphatic polyisocyanates as described above with a suitable isocyanate-reactive compound, such as, for example, a polyether polyol, polyester polyol, or low molecular weight polyol including diols and triols. The isocyanate-reactive compounds suitable for the present invention typically have a molecular weight of about 60 to about 4,000 and have a hydroxyl functionality of about 2 to about 6.

In accordance with the present invention, suitable isocyanate-reactive compounds for forming the prepolymers of the allophanate modified polyisocyanates typically have a molecular weight of at least about 60, preferably of at least about 75, more preferably at least about 100, and most preferably at least about 130. These isocyanate-reactive compounds also typically have a molecular weight of less than or equal to about 4,000, preferably of less than or equal to about 1,000, more preferably less than or equal to about 400, and most preferably less than or equal to about 200. The isocyanate-reactive compounds useful herein may have a molecular weight ranging between any combination of these upper and lower values, inclusive, e.g., from about 60 to about 4,000, preferably from about 75 to about 1,000, more preferably from about 100 to about 400, and most preferably from about 130 to about 200.

In accordance with the present invention, suitable isocyanate-reactive compounds for forming the prepolymers of the allophanate modified polyisocyanates typically have a hydroxyl functionality of at least about 2, and typically less than or equal to about 6, preferably of less than or equal to about 4, and more preferably less than or equal to about 3. The isocyanate-reactive compounds useful herein may have a hydroxyl functionality ranging between any combination of these upper and lower values, inclusive, e.g., from about 2 to about 6, preferably from about 2 to about 4, and more preferably from about 2 to about 3.

Examples of suitable isocyanate-reactive compounds include polyether polyols, polyester polyols, low molecular weight polyols including diols, triols, etc. Obviously, the above limits on molecular weight and functionality apply to each of these groups of compounds. All of these compounds are known in the field of polyurethane chemistry.

Suitable polyether polyols may be prepared by the reaction of suitable starting compounds which contain reactive hydrogen atoms with alkylene oxides such as, for example, ethylene oxide, propylene oxide, butylene oxide, styrene oxide, tetrahydrofuran, epichlorohydrin, and mixtures thereof. Suitable starting compounds containing reactive hydrogen atoms include compounds such as, for example, ethylene glycol, propylene glycol, butylene glycol, hexanediol, octanediol, neopentyl glycol, cyclohexanedimethanol, 2-methyl-1,3-propanediol, 2,2,4-trimethyl-1,3-pentanediol, triethylene glycol, tetraethylene glycol, polyethylene glycol, dipropylene glycol, polypropylene glycol, dibutylene glycol, polybutylene glycol, glycerine, trimethylolpropane, pentaerythritol, water, methanol, ethanol, 1,2,6-hexane triol, 1,2,4-butane triol, trimethylol ethane, mannitol, sorbitol, methyl glycoside, sucrose, phenol, resorcinol, hydroquinone, 1,1,1- or 1,1,2-tris-(hydroxyphenyl)-ethane, etc.

Suitable polyester polyols include, for example, the reaction products of polyhydric, preferably dihydric alcohols (optionally in the presence of trihydric alcohols), with polyvalent, preferably divalent, carboxylic acids. Instead of using the free carboxylic acids, it is also possible to use the corresponding polycarboxylic acid anhydrides or corresponding polycarboxylic acid esters of lower alcohols or mixtures thereof for producing the polyesters. The polycarboxylic acids may be aliphatic, cycloaliphatic, aromatic, and/or heterocyclic and may be unsaturated or substituted, for example, by halogen atoms. The polycarboxylic acids and polyols used to prepare the polyesters are known and described for example in U.S. Pat. Nos. 4,098,731 and 3,726,952, herein incorporated by reference in their entirety.

Suitable polythioethers, polyacetals, polycarbonates and other polyhydroxyl compounds are also disclosed in the above-identified U.S. Patents. Finally, representatives of the many and varied compounds which may be used in accordance with the invention may be found, for example, in High Polymers, Volume XVI, “Polyurethanes, Chemistry and Technology,” by Saunders-Frisch, Interscience Publishers, New York, London, Vol. I, 1962, pages 32-42 and 44-54, and Volume II, 1964, pages 5-6 and 198-199; and in Kunststoff-Handbuch, Vol. VII, Vieweg-Hochtlen, Carl Hanser Verlag, Munich, 1966, pages 45-71.

Suitable low molecular weight polyols for preparing prepolymers include, for example, diol, triols, tetrols, and low molecular weight alkoxylation products of these. These include 2-methyl-1,3-propanediol, ethylene glycol, 1,2- and 1,3-propanediol, 1,3- and 1,4- and 2,3-butanediol, 1,6-hexanediol, 1,10-decanediol, diethylene glycol, triethylene glycol, tetraethylene glycol, dipropylene glycol, tripropylene glycol, glycerol, trimethylolpropane, neopentyl glycol, cyclohexanedimethanol, 2,2,4-trimethylpentane-1,3-diol, pentaerythritol, etc. Alkoxylation products of these same compounds may also be used to prepare prepolymers. In accordance with the present invention, preferred isocyanate-reactive compounds to form prepolymers are trimethylolpropane and tripropylene glycol.

A preferred group of polyisocyanates useful herein include the prepolymers of allophanate-modified (cyclo)aliphatic polyisocyanates. These polyisocyanates are prepared by first, forming the allophanate-modified (cyclo)aliphatic polyisocyanate as described above, and then reacting the allophanate-modified polyisocyanate with a suitable isocyanate-reactive compound to form the prepolymer. This reaction is well known in the field of polyurethane chemistry, and can be carried out by, for example, heating the reactants to a temperature of from about 40 to about 150° C., preferably from about 50 to about 100° C., to yield the desired prepolymer. Obviously, an excess quantity of allophanate-modified polyisocyanate to isocyanate-reactive compound is used.

Preferred allophanate modified polyisocyanates in accordance with the present invention include those selected from the group consisting of hexamethylene diisocyanate, isophorone diisocyanate and dicyclohexylmethane diisocyanate. The resultant prepolymers of allophanate modified hexamethylene diisocyanate have a NCO group content of about 12 to about 35, preferably about 15 to about 25, and a functionality of about 2 to about 6 and preferably about 2 to about 3. The resultant prepolymers of allophanate modified isophorone diisocyanate have a NCO group content of about 10 to about 35, preferably about 15 to about 25, and a functionality of about 2 to about 6 and preferably about 2 to about 3. The resultant prepolymers of allophanate modified dicyclohexylmethane diisocyanate have a NCO group content of about 10 to about 35, preferably about 15 to about 25, and a functionality of about 2 to about 6 and preferably about 2 to about 3.

In accordance with the present invention, residues of isocyanates which may inherently result in the production of some of the above described isocyanates are not suitable for the isocyanate component herein. Such residues are undesirable by-products of the process for the production of the isocyanate components.

Suitable compounds to be used as component (B)(1) in accordance with the present invention include, for example, polyether polyols. The high molecular weight polyethers suitable for use in accordance with the invention are known and may be obtained, for example, by polymerizing tetrahydrofuran or epoxides such as, for example, ethylene oxide, propylene oxide, butylene oxide, styrene oxide or epichlorohydrin in the presence of suitable catalysts, such as, for example, BF₃ or KOH, or by chemically adding these epoxides, preferably ethylene oxide and propylene oxide, in admixture, alone or successively to suitable starter compounds which contain reactive hydrogen atoms. Examples of suitable starter compounds include, but are not limited to, propylene glycol, glycerin, ethylene glycol, butylene glycol, diethylene glycol, triethylene glycol, dipropylene glycol, tripropylene glycol, water, trimethylolpropane, tetraethylene glycol, pentaerythritol, bisphenol A, sucrose, sorbitol, etc.

As would be recognized by one of ordinary skill in the art, these types of polyether polyols contain relatively high amounts of unsaturation.

Preferred polyethers include, for example, those alkoxylation products (preferably of ethylene oxide and/or propylene oxide) based on di- or tri-functional starters such as, for example, water, ethylene glycol, propylene glycol, glycerin, trimethylolpropane, etc.

Suitable compounds to be used as (B)(1) in accordance with the present invention include those having a molecular weight of from about 1,000 to about 8,000, preferably 2,000 to about 6,000, and a hydroxyl functionality of about 2 to about 8, and preferably of about 2 to about 4. In accordance with the present invention, compounds suitable for component (B)(1) herein are free of primary, secondary and/or tertiary amine groups.

Suitable compounds to be used as (B)(2) in accordance with the present invention include those having a molecular weight of from about 62 to about 400, a hydroxyl functionality of about 2 or 3 and which are free of primary, secondary and/or tertiary amine groups. These compounds preferably have a molecular weight of from about 62 to about 90.

Some examples of suitable compounds to be used as component (B)(2) herein include compounds such as 2-methyl-1,3-propanediol, ethylene glycol, 1,2- and 1,3-propanediol, 1,3- and 1,4- and 2,3-butanediol, 1,6-hexanediol, 1,10-decanediol, diethylene glycol, triethylene glycol, tetraethylene glycol, dipropylene glycol, tripropylene glycol, tetrapropylene glycol, cyclohexanedimethanol, and 2,2,4-trimethylpentane-1,3-diol, trimethylolpropane, pentaerythritol, glycerol. Preferred diols include, for example, ethylene glycol, and trimethylol propane.

In accordance with the present invention, the reaction of component (A) with component (B) is in the presence of (C) one or more catalysts corresponding to the formula: 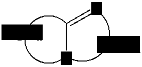
wherein:
   m: represents an integer from 3 to 8, preferably from 3 to 4;
   and
   n: represents an integer from 3 to 8, preferably from 3 to 5.

Some examples of suitable catalysts which correspond to the above identified formula include 1,8-diaza-7-bicyclo[5.4.0]undec-7-ene (i.e. DBU), 1,5-diazabicyclo[4.4.0]dec-5-ene (i.e. DBD), 1,5-diazabicyclo-[4.3.0]non-5-ene (i.e. DBN), 1,8-diazabicyclo[7.5.0]tetra-dec-8-ene, 1,8-diazabicyclo[7.4.0]tridec-8-ene, 1,8-diazabicyclo[7.3.0]-dodec-8-ene, etc.

In accordance with the present invention, the amount of catalyst corresponding to the above structure present is such that there is at least about 0.1% to about 6.0% by weight, preferably from about 0.5% to about 2.5%, and more preferably from about 1% to about 1.5% by weight, based on 100% by weight of component (B).

In accordance with the present invention, it is also possible that other catalysts which are known to be suitable for the preparation of polyurethanes may be present. Suitable catalysts include, for example, the known metal carboxylates, metal halides, ammonium carboxylates, tin-sulfur catalysts, and tertiary amine catalysts. Suitable metals for these catalysts include, but are not limited to, tin, bismuth, lead, mercury, etc. Of these catalysts, it is preferred to use tin carboxylates and/or tertiary amines in combination with the above described “diazabicyclo” catalysts.

Suitable metal carboxylates include tin carboxylates such as, for example, dimethyltin dilaurate, dibutyltin dilaurate, dibutyltin di-2-ethyl-hexoate, dibutyltin maleate, and bismuth carboxylates, such as, for example, bismuth trineodecanoate. Some suitable examples of metal halides include, for example, tin halides and particularly, tin chlorides such as, for example, dimethyltin dichloride and dibutyltin dichloride. Suitable examples of ammonium carboxylates include, for example, trimethyl-hydroxyethylammonium-2-ethylhexanoate (i.e. Dabco TMR). As previously mentioned, tin carboxylates such as, for example, dimethyltin dilaurate, and dibutyltin dilaurate are preferred metal carboxylate catalysts to be used in conjunction with the above described catalysts of the specified formula. Other suitable catalysts include tin-sulfur catalysts such as, for example, dialkyltin dilaurylmercaptides such as, for example, dibutyltin dilaurylmercaptide and dimethyltin dilaurylmercaptide. Some examples of suitable tertiary amine catalysts include compounds such as, for example, triethylamine, triethylenediamine, tributylamine, N-methyl-morpholine, N-ethylmorpholine, triethanolamine, triisopropanolamine, N-methyldiethanolamine, N-ethyldiethanolamine, and N, N-dimethylethanol-amine.

In accordance with a preferred embodiment of the present invention, it is preferred to use a catalyst which corresponds to the formula set forth above in combination comprising one or more tin carboxylate catalysts. Preferred tin carboxylates comprise dimethyltin dilaurate and/or dibutyltin dilaurate.

When a combination of two or more catalysts is used in accordance with the preferred embodiment of the present invention, the total amount of both catalysts should generally fall within the quantities previously disclosed. In other words, the total amount of all catalysts present should be such that there is at least about 0.1% to about 6.0% by weight of all catalysts, preferably from about 0.5% to about 2.5%, more preferably from about 1% to about 1.5% by weight of all catalysts, based on 100% by weight of component (B). If the preferred combination of an amine catalyst having a structure corresponding to that described above and a tin carboxylate catalyst is used in the present invention, it is preferred that the amine catalyst (of the above structure) is present in an amount of from 50 to 90% by weight, and the tin carboxylate catalyst is present in an amount of from 10 to 50% by weight, with the sum of the %'s by weight totaling 100% by weight of the catalyst component. More specifically, this would typically result in the amine catalyst corresponding the specified formula accounting for from 50 to 90% by weight of the 0.1 to 6.0% by weight of total catalyst; and the tin carboxylate catalyst accounting for from about 10 to about 50% by weight of the 0.1 to 6.0% by weight of total catalyst, with the sum of the %'s by weight of the individual catalysts totaling 100% by weight of the catalysts.

Suitable stabilizers for the present invention include light stabilizers which are considered to include any of the known compositions which are capable of preventing significant yellowing in the elastomers of the present invention. As used herein, light stabilizer may be understood to include hindered amine light stabilizers, ultraviolet (UV) absorbers, and/or antioxidants.

Some examples of hindered amine light stabilizers include, but are not limited to, compounds such as, for example, those derived from 2,2,6,6-tetraalkylpiperidine moieties, other types of hindered amines such as those containing morpholinones, piperazinones, piperazindiones, oxazolidines, imidazolines, and the like. Specific examples of suitable hindered amine light stabilizers include compounds such as, but are not limited to, bis(2,2,6,6-tetramethyl-4-piperidyl)sebacate, bis(1,2,2,6,6-pentamethyl-4-piperidyl)sebacate, 2-methyl-2-(2,2,6,6-tetramethyl-4-piperidyl)amino-N-(2,2,6,6-tetramethyl-4-piperidyl)propionamide, bis(1,2,2,6,6-pentamethyl-4-piperidyl)-2-(3,5-di-tert-butyl-4-hydroxybenzyl)-2-n-butylmalonate, tetrakis(2,2,6,6-tetramethyl-4-piperidyl)-1,2,3,4-butanetetracarboxylate, poly[{6-(1,1,3,3-tetramethylbutyl)imino-1,3,5-triazine-2,4-diyl}{(2,2,6,6-tetramethyl-4-piperidyl)imino}hexamethylene{(2,2,6,6-tetramethyl-4-piperidyl)imino}], poly[(6-morpholino-1,3,5-triazine-2,4-diyl){(2,2,6,6-tetramethyl-4-piperdyl)imino}hexamethylene{(2,2,6,6-tetramethyl-4-piperidyl)imino}], a polycondensate of dimethyl succinate and 1-(2-hydroxyethyl)-4-hydroxy-2,2,6,6-tetramethylpiperidine, a polycondensate of N,N-bis(3-aminopropyl)ethylenediamine and 2,4-bis[N-butyl-N-(1,2,2,6,6-pentamethyl-4-piperidyl)amino]-6-chloro-1,3,5-triazine, a polycondensate of 1,2,2,6,6-pentamethyl-4-piperidinol and 3,9-bis-(2-hydroxy-1,1-dimethylethyl)-2,4,8,10-tetraoxaspiro[5.5]undecane with 1,2,3,4-butanetetracarboxylic acid and bis(1-octoxy-2,2,6,6-tetramethyl-4-piperidyl)sebacate.

The benzofranone stabilizers include compounds such as, for example, 5,7-di-tert-butyl-3-(3,4-dimethylphenyl)-3H-benzofuran-2-one and the like. The semicarbazide stabilizer includes, for example, 1,6-hexamethylenebis(N,N-dimethylsemicarbazide), 4,4′-(methylenedi-p-phenylene)bis(N,N-diethylsemicarbazide), 4,4′-(methylenedi-p-phenylene)bis(N,N-diethylsemicarbazide), 4,4′-(methylenedi-p-phenylene)bis(N,N-diisopropylsemicarbazide), α,α-(p-xylylene)bis(N,N-dimethylsemicarbazide), 1,4-cyclohexylenebis(N,N-dimethylsemi-carbazide) and the like.

Suitable ultraviolet (UV) stabilizers for the present invention include compounds such as, for example, 2-(3-tert-butyl-2-hydroxy-5-methyl-phenyl)-5-chlorobenzotriazole, 2-(3,5-di-tert-butyl-2-hydroxyphenyl)benzo-triazole, 2-(2-hydroxy-5-methylphenyl)benzotriazole, 2-(2-hydroxy-5-tert-octylphenyl)benzotriazole, 2-(3,5-di-tert-amyl-2-hydroxyphenyl)benzo-triazole, 2-[2-hydroxy-3,5-bis(α,α-dimethylbenzyl)phenyl]benzotriazole, 2-hydroxy-4-octoxybenzophenone, 2-hydroxy-4-methoxybenzophenone, 2,4-di-tert-butylphenyl-3,5-di-tert-butyl-4-hydroxybenzoate, n-hexadecyl-3,5-di-tert-butyl-4-hydroxybenzoate, ethyl-2-cyano-3,3-diphenylacrylate, 2,4-dihydroxybenzophenone, 2,2′,4,4′-tetrahydroxybenzophenone, 2-(2-hydroxy-4-octoxyphenyl)benzotriazole, 2-[2-hydroxy-3,5-bis(α,α-dimethyl-benzyl)phenyl]-2H-benzotriazole, 2-(3,5-di-tert-butyl-2-hydroxyphenyl)-5-chlorobenzotriazole, a condensate of methyl 3-[3-tert-butyl-5-(2H-benzotriazole-2-yl)-4-hydroxyphenyl]propionate and polyethylene glycol (molecular weight: about 300), a hydroxyphenyl-benzotriazole derivative, 2-(4,6-diphenyl-1,3,5-triazine-2-yl)-5-hexyloxyphenol and 2-[4,6-bis(2,4-dimethylphenyl)-1,3,5-triazine-2-yl]-5-octyloxyphenol, etc., as well as mixtures thereof.

Some examples of suitable antioxidants which are useful in the present invention include compounds such as n-octadecyl-3,5-di-tert-butyl-4-hydroxyhydrocinnamate; neopentanetetrayl tetrakis(3,5-di-tert-butyl-4-hydroxyhydrocinammate); di-n-octadecyl 3,5-di-tert-butyl-4-hydroxybenzylphosphonate; 1,3,5-tris(3,5-di-tert-butyl-4-hydroxybenzyl)-isocyanurate; 1,3,5-trimethyl-2,4,6-tris(3,5-di-tert-butyl-4-hydroxybenzyl)-benzene; 3,6-dioxaoctamethylene bis(3-methyl-5-tert-butyl-4-hydroxy-hydrocinnamate); 2,2′-ethylidene-bis(4,6-di-tert-butylphenol); 1,3,5-tris(2,6-dimethyl-4-tert-butyl-3-hydroxybenzyl)isocyanurate; 1,1,3,-tris(2-methyl-4-hydroxy-5-tert-butylphenyl)butane; 1,3,5-tris[2-(3,5-di-tert-butyl-4-hydroxyhydrocinnamoyloxy)ethyl]isocyanurate; 3,5-di-(3,5-di-tert-butyl-4-hydroxybenzyl)mesitol; 1-(3,5-di-tert-butyl-4-hydroxyanilino)-3,5-di(octyl-thio)-s-triazine; N,N′-hexamethylene-bis(3,5-di-tert-butyl-4-hydroxyhydro-cinnamamide); ethylene bis[3,3-di(3-tert-butyl-4-hydroxyphenyl)butyrate]; bis(3,5-di-tert-butyl-4-hydroxyhydrocinnamoyl)hydrazide; N,N-di-(C₁₂-C₂₄ alkyl)-N-methyl-amine oxides; etc. Other suitable compounds to be used as antioxidants herein include alkylated monophenols such as, for example, 2,6-di-tert-butyl-4-methylphenol, 2-tert-butyl-4,6-dimethylphenol, 2,6-dicyclopentyl-4-methylphenol, 2,6-dioctadecyl-4-methylphenol, 2,4,6-tricyclohexylphenol, 2,6-di-tert-butyl-4-methoxymethylphenol, etc.; alkylated hydroquinones such as, for example, 2,6-di-tert-butyl-4-methoxyphenol, 2,5-di-tert-butyl-hydroquinone, 2,5-di-tert-amyl-hydro-quinone, 2,6-diphenyl-4-octadecyloxyphenol, etc.; hydroxylated thio-diphenyl ethers such as, for example, 2,2′-thio-bis-(6-tert-butyl-4-methyl-phenol), 2,2′-thio-bis-(4-octylphenol), 4,4′-thio-bis-(6-tert-butyl-2-methyl-phenol), etc.; alkylidene-bisphenols such as, for example, 2,2′-methylene-bis-(6-tert-butyl-4-methylphenol), 2,2′-methylene-bis-(4-methyl-6-cyclo-hexylphenol), 2,2′-methylene-bis-(6-nonyl-4-methylphenol), 2,2′-methyl-ene-bis-[6-(α-methylbenzyl)-4-nonylphenol], 2,2′-methylene-bis-[6-(α,α-dimethylbenzyl)-4-nonylphenol], 4,4′-methylene-bis-(2,6-di-tert-butyl-phenol), 2,6-di-(3-tert-butyl-5-methyl-2-hydroxybenzyl)-4-methylphenol, 1,1,3-tris-(5-tert-butyl-4-hydroxy-2-methylphenyl)butane, di-(3-tert-butyl-4-hydroxy-5-methylphenyl)dicyclopentadiene, di-[2-(3′-tert-butyl-2′-hydroxy-5′-methyl-benzyl)-6-tert-butyl-4-ethylphenyl]terephthalate, etc.; benzyl compounds such as, for example, 1,3,5-tri-(3,5-di-tert-butyl-4-hydroxy-benzyl)-2,4,6-trimethylbenzene, di-(3,5-di-tert-butyl-4-hydroxybenzyl)-sulfide, bis-(4-tert-butyl-3-hydroxy-2,6-dimethylbenzyl)dithiol terephthalate, etc.; acylaminophenols such as, for example, 4-hydroxy-lauric acid anilide, 4-hydroxy-stearic acid anilide, 2,4-bis-octylmercapto-6-(3,5-tert-butyl-4-hydroxyanilino)-s-triazine, etc.; amides of β-(3,5-di-tert-butyl-4-hydroxy-phenyl)propionic acid such as, for example, N,N′-di-(3,5-di-tert-butyl-4-hydroxyphenylpropionyl)hexamethylenediamine, etc.; diarylamines such as, for example, diphenylamine, N-phenyl-1-naphthyl-amine, N-(4-tert-octylphenyl)-1-naphthylamine, etc.

In accordance with the present invention, one or more pigments and/or dyes, including organic and inorganic compounds, may also be present. Suitable inorganic pigments include, for example, oxide pigments such as iron oxides, titanium dioxide, nickel oxides, chromium oxides and cobalt blue and also zinc sulfides, ultramarine, sulfides of the rare earths, bismuth vanadate and also carbon black, which is considered a pigment for the purposes of this invention. Particular carbon blacks are the acidic to alkaline carbon blacks obtained by the gas or furnace process and also chemically surface-modified carbon blacks, for example sulfo- or carboxyl-containing carbon blacks. Suitable organic pigments include, for example, those of the monoazo, disazo, laked azo, β-naphthol, Naphthol AS, benzimidazolone, diazo condensation, azo metal complex, isoindolinone and isoindoline series, also polycyclic pigments for example from the phthalocyanine, quinacridone, perylene, perinone, thioindigo, anthraquinone, dioxazine, quinophthalone and diketopyrrolopyrrole series. Suitable pigments also include solid solutions of the pigments mentioned, mixtures of organic and/or inorganic pigments with organic and/or inorganic pigments such as, for example, carbon black coated metal, mica or talc pigments, for example mica CVD-coated with iron oxide, and also mixtures between the pigments mentioned. Other suitable pigments include laked dyes such as Ca, Mg and Al lakes of sulfo- and/or carboxyl-containing dyes. Also suitable are pigments from the group of the azo metal complex pigments or their tautomeric forms which are known. Other suitable pigments include, for example, metal flake pigments of, for example, aluminum, zinc, or magnesium. It is also possible that the metal flake, particularly aluminum flake, could be leafing or non-leafing.

Other suitable additives which may be present in accordance with the invention include surface-active additives such as emulsifiers and foam stabilizers. Examples include N-stearyl-N′,N′-bis-hydroxyethyl urea, oleyl polyoxyethylene amide, stearyl diethanol amide, isostearyl diethanolamide, polyoxyethylene glycol monoleate, a pentaerythritol/adipic acid/oleic acid ester, a hydroxy ethyl imidazole derivative of oleic acid, N-stearyl propylene diamine and the sodium salts of castor oil sulfonates or of fatty acids. Alkali metal or ammonium salts of sulfonic acid such as dodecyl benzene sulfonic acid or dinaphthyl methane sulfonic acid and also fatty acids may also be used as surface-active additives.

Suitable foam stabilizers include water-soluble polyether siloxanes. The structure of these compounds is generally such that a copolymer of ethylene oxide and propylene oxide is attached to a polydimethyl siloxane radical. Such foam stabilizers are described, for example, in U.S. Pat. No. 2,764,565. In addition to the foam stabilizers and surface-active agents, other additives which may be used in the molding compositions of the present invention include known blowing agents including nitrogen, cell regulators, flame retarding agents, plasticizers, adhesion promoters, fillers and reinforcing agents such as glass in the form of fibers or flakes or carbon fibers.

It is also possible to use the known internal mold release agents, such as, for example, zinc stearate, in the RIM process of the invention. As is known to one of ordinary skill in the art, in the RIM process, an isocyanate, and active hydrogen containing compounds are mixed and injected into molds, wherein the reactants are allowed to react fully.

The molded products of the present invention are prepared by reacting the components in a closed mold via the RIM process. The compositions according to the present invention may be molded using conventional processing techniques at isocyanate indexes ranging from about 90 to 120 (preferably from 100 to 110. By the term “Isocyanate Index” (also commonly referred to as NCO index), is defined herein as the equivalents of isocyanate, divided by the total equivalents of isocyanate-reactive hydrogen containing materials, multiplied by 100.

In general, in a RIM process, two separate streams are intimately mixed and subsequently injected into a suitable mold, although it is possible to use more than two streams. The first stream contains the polyisocyanate component, while the second stream contains the isocyanate reactive components and any other additive which is to be included.

The following examples further illustrate details for the preparation and use of the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions. Unless otherwise noted, all temperatures are degrees Celsius and all parts and percentages are parts by weight and percentages by weight, respectively.

### EXAMPLES

The following components were used in the examples of the present application:
Isocyanate A: an allophanate based on IPDI and isobutanol was prepared with by reacting 3148 g (28.3 eq.) IPDI with 172 g (2.3 eq.) isobutanol. The resultant allophanate had an NCO content of 30.1%. Then, the prepolymer of the allophanate was prepared by adding 196 g (2.0 eq.) trimethylol propane to the above allophanate. The resultant prepolymer had an NCO content of 25.9%.
Polvol A: a polyether polyol having a nominal functionality of about 3, an OH number of about 28, a molecular weight of about 6000, and comprising the reaction product of glycerin with propylene oxide and capped with ethylene oxide in the presence of a KOH catalyst
EG: ethylene glycol
Catalyst A: dimethyltin dilaurate catalyst, commercially available as Fomrez UL-28 from GE Silicones
Catalyst B: 1,8-diazobicyclco(5.4.0)undec-7-ene catalyst, commercially available as Polycat DBU from Air Products
Surfactant A: a silicone surfactant, commercially available as Niax L-1000 from GE Silicones
Pigment A: a carbon black polyol dispersion pigment, commercially available as Colormatch DR-20845 from Plasticolors Corp.
UV Stabilizer: a combination ultraviolet stabilizer, commercially available as Tinuvin B 75 from Ciba Corp.
   General Procedure:

The components described above were used to produce reaction injected molded articles. The specific materials and the amounts of those materials used are reported in Table 1 which follows.

The polyurethane-forming systems of Examples 1-2 were injected using a MiniRIM cylinder machine. The isocyanate-reactive materials and various additives were put into the B-side of the machine, and the appropriate quantities of the isocyanate component were loaded into the A-side. The MiniRIM was equipped with a Hennecke mq8 Mixhead. The B-side was preheated to 90° F. and the A-side was heated to 90° F. The materials were injected at an injection pressure of 200 bar and an injection rate of 400 grams/sec. The material was injected into a flat plaque mold of 3×200×300 mm heated to about 165° F. After a 60 second dwell time, the part was demolded. Physical properties were determined in accordance with ASTM standards.

The following ASTM test methods were used in the working examples of the present application.

ASTM Tests

| Property | ASTM Test Number |
|---|---|
| Flexural Modulus | D 3489 (D 790 Method I) |
| Shore A Hardness | HA2240 |
| Shore D Hardness | HD2240 |
| Tear Strength | D624 |
| Tensile Strength | D412 |
| Ultimate % Elongation | D412 |

TABLE 1
Formulations for Examples 1-2

| Formula | Example 1 | Example 2 |
|---|---|---|
| Polyol A | 80 | 88 |
| EG | 20 | 12 |
| Catalyst A | 1 | 1 |
| Catalyst B | 2 | 2 |
| Surfactant A | 1 | 1 |
| UV Stabilizer | 5 | 5 |
| Pigment A | 5 | 5 |
| Iso A | 116.8 | 73.6 |
| Isocyanate Index | 105 | 105 |
| Gel Time (sec) | 4 | 8 |
| Shot Time (sec) | 1 | 1 |
| Demold Time (mins) | 5 | 5 |
| Panel Density (pcf) | 68 | 68 |
| No. of Samples | 6 | 6 |

TABLE 2
Properties of Examples 1-2

| Property | Example 1 | Example 2 |
|---|---|---|
| Density (pcf) | 61.8 | 66.35 |
| Flex Modulus (psi) | 25,750 | 3,906 |
| Hardness - Shore A @ 1 sec. | 96 | 87 |
| Hardness - Shore D @ 1 sec. | 55 | 36 |
| Tear Strength - Die C (pli) | 433.1 | 352.8 |
| Tensile Strength (psi) | 2387 | 1956 |
| Elongation (%) | 259.1 | 366.3 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the production of a polyurethane elastomer comprising reacting a reaction mixture by a reaction injection molding technique, wherein the reaction mixture comprises:
(A) a polyisocyanate component comprising (I) an allophanate-modified polyisocyanate having an NCO group content of about 15 to about 35% by weight, and comprising the reaction product of:
(1) a (cyclo)aliphatic polyisocyanate having an NCO group content of about 25 to about 60% NCO,
with
(2) an organic alcohol selected from the group consisting of aliphatic alcohols containing from 1 to 36 carbon atoms, cycloaliphatic alcohols containing from 5 to 24 carbon atoms and aromatic alcohols containing from about 7 to about 12 carbon atoms in which the alcohol group is not directly attached to an aromatic carbon atom;
with
(B) an isocyanate-reactive component comprising:
(1) from about 70 to about 90% by weight, based on 100% by weight of (B), of one or more polyether polyols having a functionality of from about 2 to about 8, a molecular weight of about 1,000 to about 8,000 and is free of amine groups;
(2) from about 10 to about 30% by weight, based on 100% by weight of (B), of one or more organic compounds having a molecular weight of from about 62 to about 400, having a hydroxyl functionality of 2 to 3, and is free of amine groups,
in the presence of
(C) one or more catalysts corresponding to the formula: 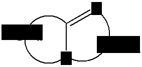
wherein:
m: represents an integer from 3 to 8,
and
n: represents an integer from 3 to 8;
and, optionally,
(D) one or more additives;
wherein the relative amounts of (A) and (B) are such that the isocyanate index ranges from about 90 to about 120.

2. The process of claim 1, wherein (A) said polyisocyanate component comprises a prepolymer which comprises the reaction product of:
(I) an allophanate-modified polyisocyanate having an NCO group content of about 15 to about 35% by weight,
and
(II) an isocyanate-reactive component having a functionality of from about 2 to about 6 and a molecular weight of about 60 to about 4,000,
wherein the resultant prepolymer has an NCO group content of about 10% to about 35%.

3. The process of claim 1, wherein the (cyclo)aliphatic polyisocyanate is selected from the group consisting of 1-isocyanato-3-isocyanatomethyl-3,5,5-trimethylcyclohexane, dicyclohexylmethane-4,4′-diisocyanate and 1,6-hexamethylene diisocyanate.

4. The process of claim 2, wherein the (cyclo)aliphatic polyisocyanate is selected from the group consisting of 1-isocyanato-3-isocyanatomethyl-3,5,5-trimethylcyclohexane, dicyclohexylmethane-4,4′-diisocyanate and 1,6-hexamethylene diisocyanate.

5. The process of claim 1, wherein (B)(1) has a functionality of 2 to 4 and a molecular weight of 2,000 to 6,000.

6. The process of claim 1, wherein (B)(2) has a molecular weight of 62 to 90.

7. The process of claim 1, wherein (C) comprises 1,8-diazabicyclo(5.4.0)undec-7-ene.

8. The process of claim 1, wherein (C) additionally comprises a tin catalyst.

9. The process of claim 1, wherein (D) said one or more additives comprises one or more stabilizers selected from the group consisting of antioxidants, hindered amine light stabilizers and ultraviolet stabilizers.

10. The process of claim 1, wherein (D) said one or more additives comprises one or more pigments and/or dyes.

11. A polyurethane elastomer comprising the reaction product of:
(A) a polyisocyanate component comprising (I) an allophanate-modified polyisocyanate having an NCO group content of about 15 to about 35% by weight, and comprising the reaction product of:
(1) a (cyclo)aliphatic polyisocyanate having an NCO group content of about 25 to about 60% NCO,
with
(2) an organic alcohol selected from the group consisting of aliphatic alcohols containing from 1 to 36 carbon atoms, cycloaliphatic alcohols containing from 5 to 24 carbon atoms and aromatic alcohols containing from about 7 to about 12 carbon atoms in which the alcohol group is not directly attached to an aromatic carbon atom;
with
(B) an isocyanate-reactive component comprising:
(1) from about 70 to about 90% by weight, based on 100% by weight of (B), of one or more polyether polyols having a functionality of from about 2 to about 8, a molecular weight of about 1,000 to about 8,000 and is free of amine groups;
(2) from about 10 to about 30% by weight, based on 100% by weight of (B), of one or more organic compounds having a molecular weight of from about 62 to about 400, having a hydroxyl functionality of 2 to 3, and is free of amine groups,
in the presence of
(C) one or more catalysts corresponding to the formula: 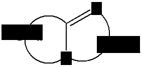
wherein:
m: represents an integer from 3 to 8,
and
n: represents an integer from 3 to 8;
and, optionally,
(D) one or more additives;
wherein the relative amounts of (A) and (B) are such that the isocyanate index ranges from about 90 to about 120.

12. The elastomer of claim 11, wherein (A) said polyisocyanate component comprises a prepolymer which comprises the reaction product of:
(I) an allophanate-modified polyisocyanate having an NCO group content of about 15 to about 35% by weight,
and
(II) an isocyanate-reactive component having a functionality of from about 2 to about 6 and a molecular weight of about 60 to about 4,000,
wherein the resultant prepolymer has an NCO group content of about 10% to about 35%.

13. The elastomer of claim 11, wherein the (cyclo)aliphatic polyisocyanate is selected from the group consisting of 1-isocyanato-3-isocyanatomethyl-3,5,5-trimethylcyclohexane, dicyclohexylmethane-4,4′-diisocyanate and 1,6-hexamethylene diisocyanate.

14. The elastomer of claim 12, wherein the (cyclo)aliphatic polyisocyanate is selected from the group consisting of 1-isocyanato-3-isocyanatomethyl-3,5,5-trimethylcyclohexane, dicyclohexylmethane-4,4′-diisocyanate and 1,6-hexamethylene diisocyanate.

15. The elastomer of claim 11, wherein (B)(1) has a functionality of 2 to 4 and a molecular weight of 2,000 to 6,000.

16. The elastomer of claim 11, wherein (B)(2) has a molecular weight of 62 to 90.

17. The elastomer of claim 11, wherein (C) comprises 1,8-diazabicyclo(5.4.0)undec-7-ene.

18. The elastomer of claim 11, wherein (C) additionally comprises a tin catalyst.

19. The elastomer of claim 11, wherein (D) said one or more additives comprises one or more stabilizers selected from the group consisting of antioxidants, hindered amine light stabilizers and ultraviolet stabilizers.

20. The elastomer of claim 11, wherein (D) said one or more additives comprises one or more pigments and/or dyes.
